(19) United States
(12) Patent Application Publication
(10) Pub. No.: US 2006/0280662 A1
(43) Pub. Date: Dec. 14, 2006

(54) Micro reformer and micro fuel cell having the same

(75) Inventors: Jae Hyuk Jang, Sungnam (KR); Sung Han Kim, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/449,627

(22) Filed: Jun. 9, 2006

(30) Foreign Application Priority Data
Jun. 10, 2005 (KR) 10-2005-0049916

(51) Int. Cl. H01M 8/06; B01J 19/00

(52) U.S. Cl. 422/198; 422/202; 429/20

(57) ABSTRACT

The invention relates to a micro reformer using a liquid fuel like methanol, and a micro fuel cell having the same. The invention provides a micro reformer including a cylindrical tube having an inlet for receiving a liquid fuel and an outlet for emitting hydrogen gas. The micro reformer also includes a heater disposed in the tube for providing a heat source, and a catalyst disposed in the tube for producing hydrogen gas from hydrocarbon-based fuel. According to the invention, the micro reformer and the micro fuel cell can be integrated using a wire type for various purposes, allowing obtainment of a miniaturized fuel cell using methanol liquid fuel.

### CLAIM OF PRIORITY

This application claims the benefit of Korean Patent Application No. 2005-49916 filed on Jun. 10, 2005, in the Korean Intellectual Property Office, the disclosure of which is incorporated herein by reference.

### BACKGROUND OF THE INVENTION

1. Field of the Invention

The present invention relates to a micro reformer using a liquid fuel like methanol and a micro fuel cell using the same, and more particularly, a wire type micro reformer in which a fuel cell stack and a fuel reformer are integrated using a wire to form a miniaturized portable power source, and a micro fuel cell using the same.

2. Description of the Related Art

In general, a fuel cell includes various types such as a polymer electrolyte fuel cell, a direct methanol fuel cell, a molten carbonate fuel cell, a solid oxide fuel cell, a phosphoric acid fuel cell, and an alkaline fuel cell. Among these, the most extensively used portable micro fuel cells include the Direct Methanol Fuel Cell (DMFC) and the Polymer Electrolyte Membrane Fuel Cell (PEMFC). The DMFC and PEMFC adopt the same components and material but the former uses methanol and the latter uses hydrogen gas, and thus have different and comparable capabilities and fuel supply systems.

The DMFC uses hydrocarbon liquid fuels like methanol and ethanol, thus has advantages in storage, stability, and miniaturization compared with the PEMFC. But its energy density level is lower than that of the PEMFC which uses hydrogen gas. In order to overcome such a drawback, there have been active researches recently on the PEMFC adopting a reformer for producing hydrogen from a liquid fuel.

In the meantime, the PEMFC gas type fuel cell generates electricity via chemical reactions as shown-below.
2H₂--->4H⁺+4e⁻
O₂+4e⁻+4H⁺--->2H₂O

Therefore, electricity is generated through the reaction represented by 2H₂+O₂--->2H₂O.

Although the PEMFC gas type fuel cell has a merit of high energy density, use of hydrogen gas requires careful handling, and other additional equipments for handling methanol or alcohol to produce hydrogen gas for a fuel gas, thus increasing the volume.

In addition, it is advantageous for the conventional fuel cells such as the DMFC and the PEMFC to have a cylindrical shape to replace the power source of the portable electronic devices since most of the first and second batteries such as a lithium ion battery have a cylindrical shape.

However, the conventional fuel cells have a planar or a parallelepiped stack, and thus difficult to be realized in a cylindrical shape.

FIG. 1 illustrates a fuel cell 300 according to the prior art.

This fuel cell 300 is disclosed in U.S. Pat. No. 6,444,339 assigned to Microcell Corporation, and includes a plurality of micro cell bundles 304 and heat exchange tube type collective electrodes 306 inside a tube sheet 302. However, there is no mention of a reformer for this fuel cell.

FIG. 2 illustrates another conventional fuel cell 310, which is disclosed in U.S. Pat. No. 5,827,620 assigned to Keele University. This fuel cell includes a cylindrical electrolyte tube 312 with a cylindrical fuel electrode 314 in an inner side thereof and an air electrode 316 in an outer side thereof. But there is also no mention of a reformer for this fuel cell 310.

FIG. 3 illustrates yet another conventional fuel cell 330 disclosed in U.S. Pat. No. 5,244,752. This fuel cell 330 has an air preheater 334 next to an electricity generator 332 which is composed of a cylindrical electrolyte pipe with a cylindrical fuel electrode outside thereof and a cylindrical air electrode inside thereof. But there is no mention of a reformer for this fuel cell 330.

Therefore, there has been a constant demand for a micro reformer appropriate for a micro fuel cell.

### SUMMARY OF THE INVENTION

The present invention has been made to solve the foregoing problems of-the prior art and therefore an object according to certain embodiments of the present invention to provide a wire type micro reformer having a cylindrical structure to substitute a cylindrical battery, and a micro fuel cell having the same.

Another object according to certain embodiments of the invention is to provide a wire type micro reformer manufactured using a flexible material to be bent or wound, and a micro fuel cell having the same.

According to an aspect of the invention for realizing the object, there is provided a micro reformer including: a cylindrical tube having an inlet for receiving a liquid fuel and an outlet for emitting hydrogen gas; a heater disposed in the tube for providing a heat source; and a catalyst disposed in the tube for producing hydrogen gas from hydrocarbon-based fuel.

According to another aspect of the invention for realizing the object, there is provided a micro fuel cell for generating electricity from a liquid fuel including: a reformer for producing hydrogen gas from a liquid fuel, the reformer including a cylindrical tube having an inlet for receiving the liquid fuel and an outlet for emitting hydrogen gas, a heater disposed in the tube for providing a heat source, and a catalyst disposed in the tube for producing hydrogen gas from hydrocarbon-based fuel; a connector having an end connected to the outlet; and a stack connected to the other end of the connector to receive the hydrogen gas, having a catalyst layer, an electrolyte membrane, and a coil. electrode therein, thereby generating current using the hydrogen gas.

According to yet another aspect of the invention for realizing the object, there is provided a micro fuel cell for generating electricity from a liquid fuel including: a reformer for producing hydrogen gas from a liquid fuel, the reformer including a cylindrical tube having an inlet for receiving the liquid fuel and an outlet for emitting hydrogen gas, a heater disposed in the tube for providing a heat source, and a catalyst disposed in the tube for producing hydrogen gas from hydrocarbon-based fuel; a stack wrapped around the reformer to receive the hydrogen gas, having a catalyst layer, an electrolyte membrane, and a coil electrode therein to generate current using the hydrogen gas; and a connector for connecting the reformer and the stack to overlap each other, forming a dual cylinder.

### BRIEF DESCRIPTION OF THE DRAWINGS

The above and other objects, features and other advantages of the present invention will be more clearly understood from the. following detailed description taken in conjunction with the accompanying drawings, in which:

FIG. 1 illustrates a micro fuel cell according to the prior art;

FIG. 2 is a cross-sectional view illustrating another micro fuel cell according to the prior art;

FIG. 3 is a cross-sectional view illustrating yet another micro fuel cell according to the prior art;

FIG. 4 is a partially cutaway perspective view illustrating a micro reformer according to the present invention;

FIG. 5 illustrates the micro reformer shown in FIG. 4 in which (a) is a sectional view including a catalyst as pellets, and (b) is a sectional view including a catalyst coated on a wall;

FIG. 6 is a partially cut-away perspective view illustrating a stack provided in the fuel cell according to the present invention;

FIG. 7a is a perspective view illustrating an exterior of a single-wall micro fuel cell according to the present invention;

FIG. 7b is a cross-sectional view of the micro fuel cell shown in FIG. 7a;

FIG. 8a is a perspective view illustrating a double-wall micro fuel cell according to the present invention; and

FIG. 8b is a sectional view of the dual-wall micro fuel cell shown in FIG. 8a.

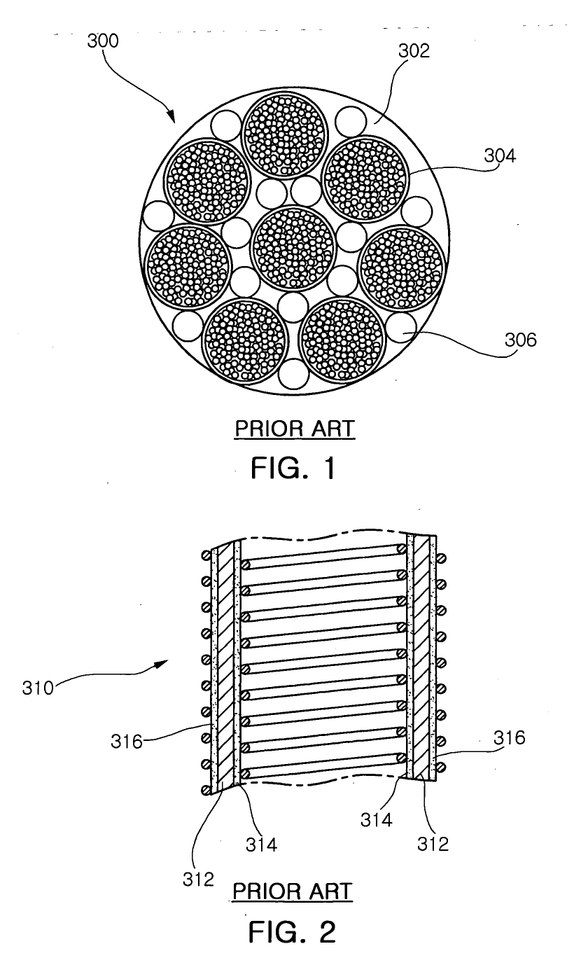

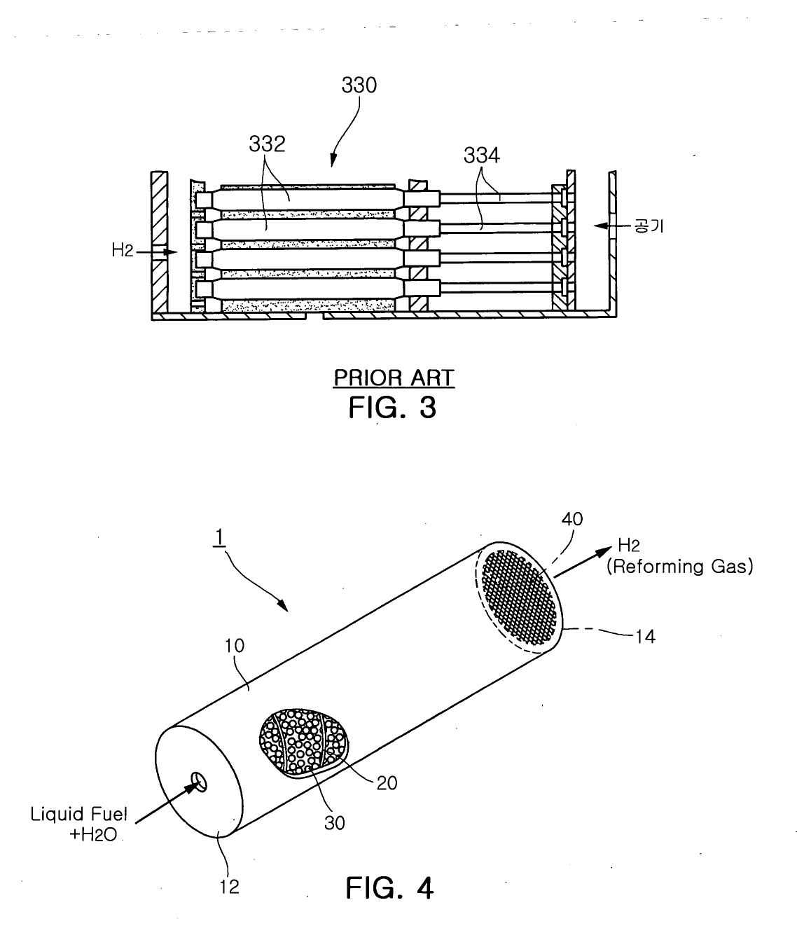

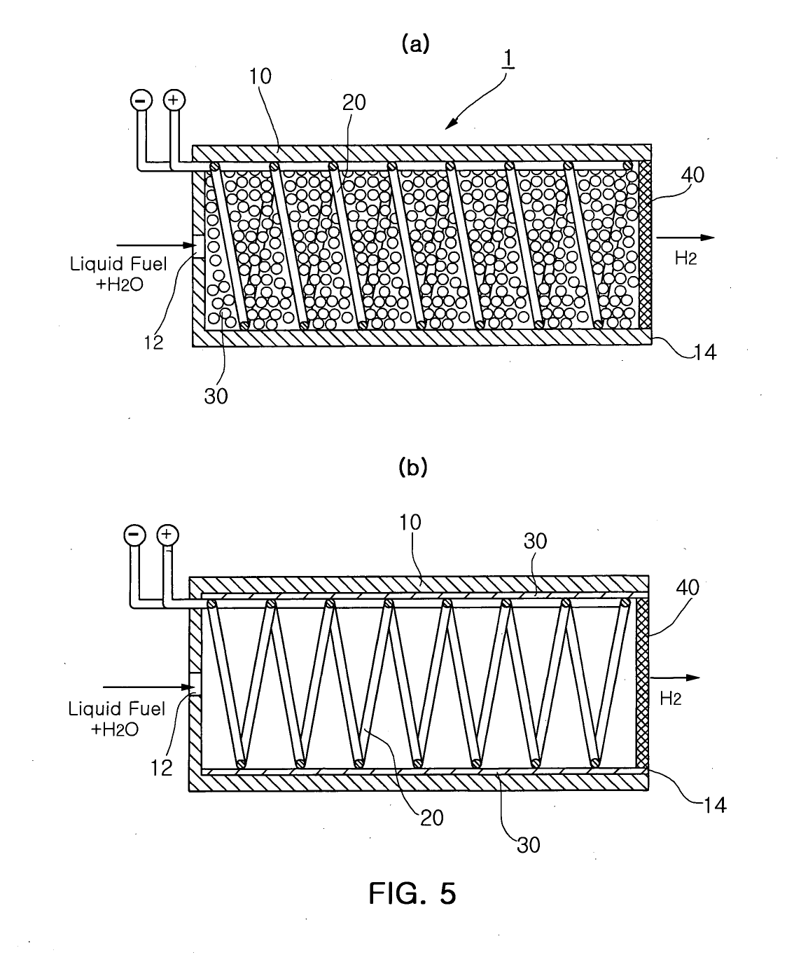

### DETAILED DESCRIPTION OF THE PREFERRED EMBODIMENT

Preferred embodiments of the present invention will now be described in detail with reference to the accompanying drawings.

The present invention relates to a micro reformer which produces hydrogen from hydrocarbon-based liquid fuel like methanol and ethanol.

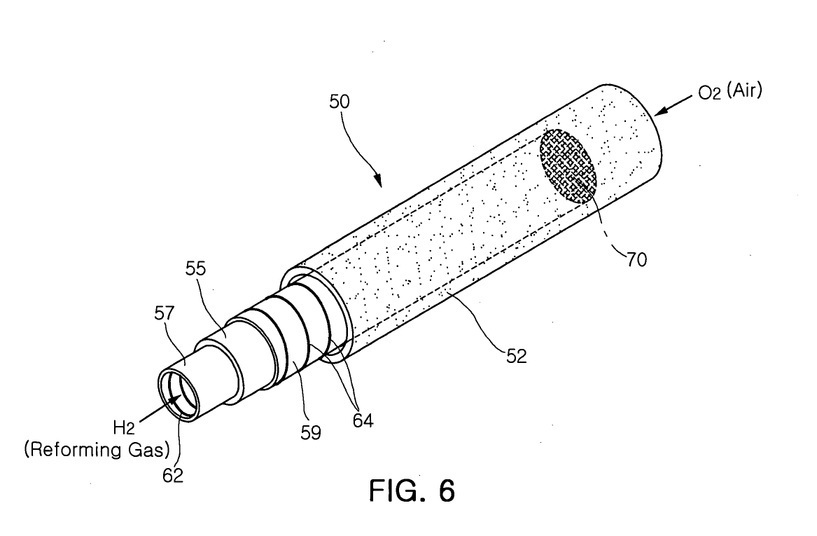

As shown in FIG. 4, the micro reformer 1 according to the present invention has a cylindrical tube 10 made of a material which can sustain a high temperature of about 300° C.

The tube 10 has an inlet 12 in an end thereof for receiving the liquid fuel, and an outlet 14 in the opposite end thereof for emitting hydrogen gas.

In addition, the tube 10 can be made of glass, teflon (PTFE), and ceramics, and houses a heater 20 and a catalyst 30 therein.

The heater 20 is disposed in the tube 10, providing a heat source, and is preferably composed of hot wires using electric resistance.

Such a heater 20 provides a heat source since high temperature of heat ranging from 120° C. to 300° C. is required to reform a liquid fuel. Alternatively, the heater 20 may be removed if a reforming reaction such as auto thermal reforming and Partial Oxidation (POX) is applied other than steam reforming. The heater 20 may adopt heating methods other than the electric resistance method.

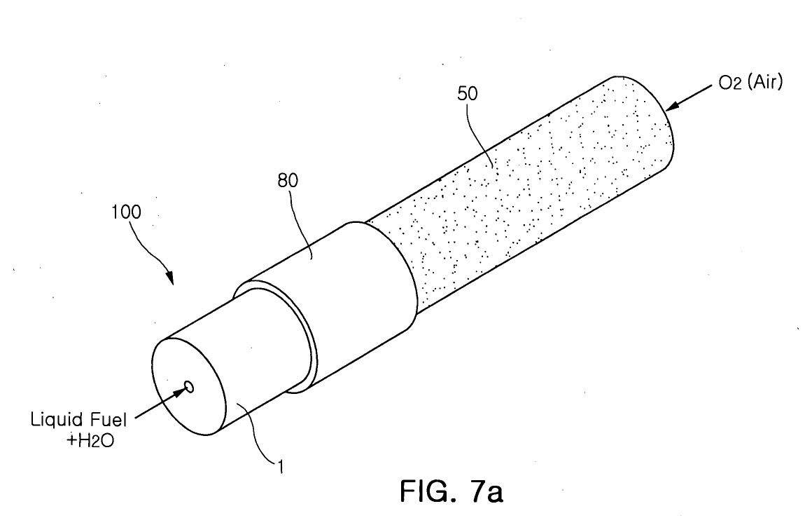

In addition, the micro reformer 1 has a catalyst 30 disposed in the tube 10, producing hydrogen gas from hydrocarbon-based fuel. The catalyst 30 is composed of Cu/ZnO/Al₂O₃ and CuO/ZnO/Al₂O₃, and as shown in FIG. 5(a), can be charged inside the tube as pellets. Alternatively, as shown in FIG. 5(b), the catalyst 30 can be coated on an inner wall of the tube 10, and although not shown, it can also take a form of a cylinder coaxially maintained in the tube by a support made of porous material.

The micro reformer 1 with the above configuration is supplied with a fuel through the inlet 12 of the tube 10. That is, in case of steam reforming, a liquid fuel such as hydrocarbon-based methanol (CH₃OH) or ethanol and steam (H₂O) is supplied, and in case of partial oxidation, the steam (H₂O) is substituted with oxygen (O₂) so that a liquid fuel and oxygen is supplied.

When the liquid fuel is injected, the liquid fuel reacts to the catalyst 30 at high temperature by the heater 20, producing reforming gas (mostly hydrogen H₂). However, the reforming gas produced by the present invention may include CO and C0₂ which degrade the catalyzing capabilities of a stack that generates electricity in a fuel cell.

Therefore, the micro reformer 1 according to the present invention may have a hydrogen permeable membrane 40 at an end of the outlet 14 of the tube 10, allowing passage of hydrogen. The hydrogen permeable membrane 40 may be made of porous member having Pd alloys, etc. coated thereon.

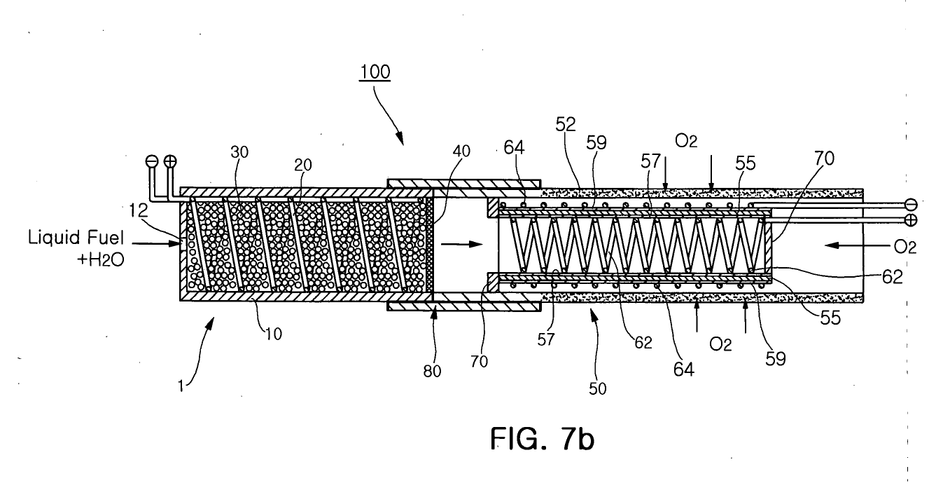

According to the present invention, the above described micro reformer 1 can be connected to a stack 50 of a fuel cell shown in FIG. 6. The micro reformer 1 connected with the stack 50 can form an integrated cylindrical fuel cell which produces hydrogen from a liquid fuel such as methanol and ethanol, generating electricity from the hydrogen.

The stack 50 has a cylindrical body 52 which can be made of the same material as the tube 10 of the micro reformer 1, such as glass, teflon (PTFE) and ceramics, and should be able to sustain high temperature of about 150° C. In addition, it is preferable that the body 52 is a porous structure having a plurality of pores through which the outside air is supplied.

The body 52 has a tubular Membrane Electrode Assembly (MEA) 55 disposed therein coaxially with the body 52. The MEA is composed of a polybenzimidizole (PBI)-based electrolyte membrane, having an anode catalyst layer 57 made of Pt/Ru and a cathode catalyst layer 59 made of Pt formed in inner and outer sides thereof, respectively, and should be able to sustain high temperature.

The MEA 55 may also adopt a hydrocarbon-based or a fluorine-based electrode membrane such as nation, which, however, should be humidified appropriately when used.

The MEA 55 has wires 62 and 64 wound in a spiral on inner and outer surfaces thereof. The wires are made of Cu having high conductivity for migration of electrons, and function as a current collector while supporting.the MEA 55.

The wires 62 and 64 can be woven in a net instead of forming a spiral, supporting and maintaining the tubular shape of the MEA 55.

Hydrogen gas or reforming gas flows into an anode side of the MEA of the stack 50, or an inner cavity, to react with the anode catalyst layer 57, losing an electron while the hydrogen is ionized (H+) as represented below.
2H₂--->4H⁺+4e⁻.

Concurrently, the hydrogen electron generated migrates to the outside through the inner wire 62, and the hydrogen ion passes through the MEA 55 to move over to the cathode catalyst layer 59. Therefore, the hydrogen ion passed through the MEA reacts with the cathode catalyst layer 59, i.e., oxygen O₂ flowed into an outer cavity of the MEA 55 or oxygen in the air to form water H₂O as represented below.
O₂+4e⁻+4H⁺--->2H₂O
2H₂+O₂--->2H₂O

Concurrently, the electron migrates via the wires 62 and 64, thereby generating direct current DC as in a general fuel cell.

In the above described stack 50, the inner cavity and the outer cavity of the MEA 55 should be strictly differentiated by a barrier 70. This prevents hydrogen in the anode side from flowing into the cathode side, and the air in the cathode side from flowing into the anode side.

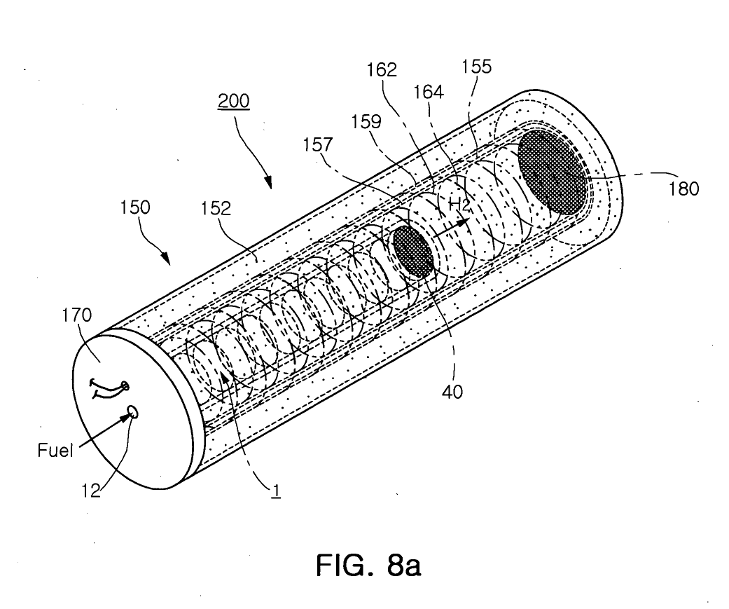

The above described micro reformer 1 and the stack 50 can be disposed linearly coaxially to form a single-wall fuel cell 100 as shown in FIGS. 7a and 7b.

That is, as shown in FIGS. 7a and 7b, the micro fuel cell 100 is provided with a micro reformer 1 in one side thereof for producing hydrogen gas from a liquid fuel, having a cylindrical tube 10 with an inlet 12 for receiving the liquid fuel and an outlet 14 for emitting hydrogen gas, a heater 20 disposed in the tube 10 for providing a heat source, and a catalyst 30 disposed in the tube 10 for producing hydrogen gas from hydrocarbon-based fuel.

In addition, the micro fuel cell 100 has a connector 80 having an end connected to the outlet 14 of the micro reformer 1. The connector 80 is in a cylindrical shape connecting the micro reformer 1 with the stack 50 explained later. The connector 80 may be made of the same material as the tube 10 of the micro reformer 1 or the body 52 of the stack 50, such as glass, teflon, and ceramics, and can be bonded to the micro reformer 10 and the stack 50.

As described above, disposed at the other end of the connector 80, the stack 50 having catalyst layers 57 and 59, an MEA 55 and coil electrodes 62 and 64 therein receives hydrogen gas from the connector 80, thereby generating current using the hydrogen gas.

As shown in FIG. 7b, in the micro fuel cell 100 described above, hydrogen gas is received through a hydrogen permeable membrane 40 of the micro-reformer 1 into the connector 80, then flows into the anode side of the MEA 55, i.e., the inner cavity, and is blocked by a barrier 70 from moving out of the MEA 55.

The hydrogen gas or the reforming gas reacts with the anode catalyst 57, losing an electron while the hydrogen is ionized (H+). Concurrently, the hydrogen generated moves to the outside via the inner anode wire 62, and the hydrogen ion pass through the MEA 55 to move over to the side of the cathode catalyst layer 59. Therefore, the hydrogen ion passed through the MEA 55 reacts with oxygen O₂ flowed into the outer cavity of the MEA 55 or oxygen in the air to form water (H₂O), and thereby the electron migrates along the wires 62 and 64, generating electricity.

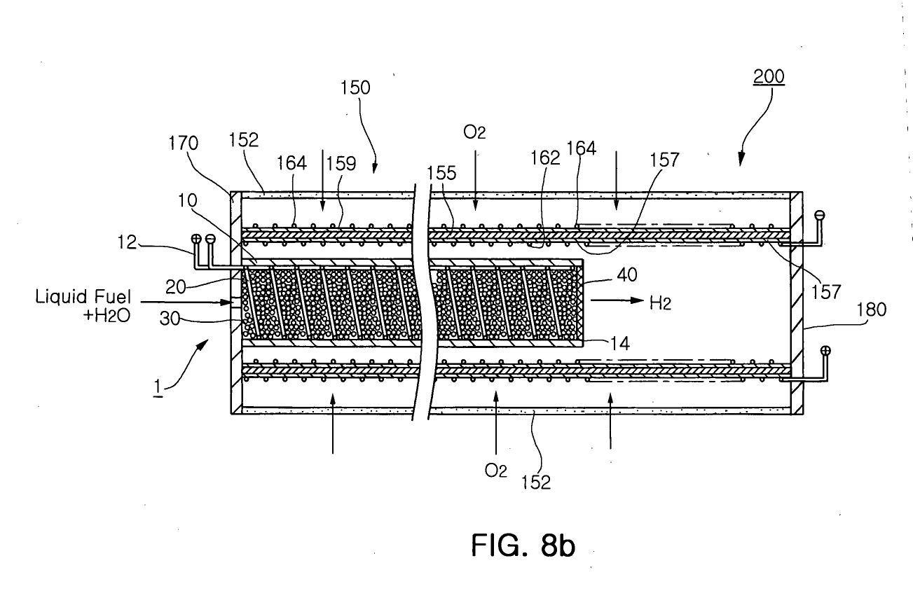

FIGS. 8a and 8b illustrate a double-wall fuel cell 200 according to the present invention, alternative to the foregoing fuel cell;

As shown in FIG. 8, the double wall fuel cell 200 is provided with a micro reformer 1 for producing hydrogen gas from a liquid fuel including a cylindrical tube 10 having an inlet for receiving the liquid fuel and an outlet 14 for emitting hydrogen gas, a heater 20 disposed in the tube 10 for providing a heat source, and a catalyst 30 disposed in the tube 10 for producing hydrogen gas from hydrocarbon-based fuel.

The micro fuel cell 200 includes a stack 150 having catalyst layers 157 and 159, electrode membrane 159 and coil electrodes 162 and 164 inside the cylindrical body 152 thereof, wrapped around the micro reformer 1 to receive hydrogen gas, thereby generating current using the hydrogen gas, and a connector 170 for connecting to overlap the micro reformer 1 and the stack 150 in a dual cylinder structure.

That is, the double wall fuel cell 200 has the micro reformer 1 in the inner space of the stack 150 having a large circumference. The fuel cell 200 utilizes high temperature (e.g. 250° C. to 300° C.)of heat generated from the micro reformer 1 to maintain the stack 150 at a temperature ranging from 60° C. to 150° C.

The stack 150 has a cylindrical body 152 having a larger circumference than the micro reformer 1. The body 152 of the stack 150 can be made of the same material as the tube 10 of the micro reformer 1 such as glass, teflon (PTFE), and ceramics, and should be able to sustain high temperature of about 150° C. In addition, to facilitate supply of the outside air, the body 152 is preferably a porous structure having a plurality of pores.

In addition, the body 152 has an MEA 155 having a larger circumference than the micro reformer 1 disposed coaxially with the tube 10. The MEA 155 may be a polybenzimidizole (PBI)-based electrolyte membrane and has the anode catalyst layer 157 made of Pt/Ru inside thereof, and a cathode catalyst layer 159 made. of Pt outside thereof 159.

The MEA 155 has wires 162 and 164 wound on the inner and outer surfaces thereof in a spiral, made of Cu having a high conductivity for migration of the electrons, functioning as a current collector while supporting the MEA 155.

In the above described stack 150, hydrogen gas or reforming gas flows into the anode side, i.e., the inner cavity of the MEA 155, then passes through the MEA 155 to react with oxygen contained in the outside air while the electron migrates via the inner wire 162 to the outer wire 164, thereby generating direct current.

As shown in FIGS. 8a and 8b, the present invention also provides a circular plate-shaped connector 170 to connect the micro reformer 1 and the stack 150 coaxially so that they form a dual cylinder structure. The connector 170 has a plate shape connecting an end of the micro reformer with an end of the stack 150. Thereby, the tube 10 of the micro reformer 1 and the body 152 of the stack 150 are integrally fixed with an adhesive to the connector 170 such that the stack 150 surrounds the micro, reformer 1, forming a double wall structure.

The above described double wall fuel cell 200 has. a barrier 180 at the opposite side of the connector 170 to restrict movement of the hydrogen gas such that when hydrogen gas passes through a hydrogen filtering membrane 40 of the micro reformer 1 and received inside the stack 150, the hydrogen gas is inhibited from passing through the MEA 155 of the stack 150, from the anode side, ie., the inner cavity to the cathode side, i.e., the outer cavity.

Through the above described processes with reference to FIGS. 7a and 7b, the double wall fuel cell 200 generates direct current.

According to certain embodiments of the present invention set forth above, a micro reformer and a stack can be integrated using a wire form to materialize a PEMFC. According to certain embodiments of the present invention, the stack is supplied with air through a cylindrical body thereof and also has a catalyst layer on the surface thereof to be in contact with air, and thus there is no need for additional air supply. This configuration allows obtainment of a micro fuel cell using methanol liquid fuel.

In addition, in case of a single wall type, a certain embodiment of the present invention provides a flexible structure of a fuel cell that can be bent or wound, which is applicable to various areas. In case of a double-wall fuel cell, the stack can utilize heat from the reformer, achieving enhanced electricity generation efficiency.

Moreover, a certain embodiment of the invention is easy to manufacture in an integrated form with wires provided in a spiral functioning as a current collector, thereby structurally reinforcing the tube of the reformer or the body of the stack. Thereby the reformer and the stack can be bent or wound in a desired form to be used.

Conventionally, only the DMFC has been popular as a portable and mobile fuel cell but with a problem of low output. Certain embodiments of the present invention can solve this problem and can be applied to all kinds of conventional portable devices requiring a micro fuel cell as well as devices that are not compatible with a conventional fuel cell.

Certain exemplary embodiments of the invention have been explained and shown in the drawings as presently preferred. The invention may, however, be embodied in many different forms and should not be construed as limited to the embodiments set forth herein. While the present invention has been shown and described in connection with the preferred embodiments, it will be apparent to those skilled in the art that modifications and variations can be made without departing from the spirit and scope of the invention as defined by the appended claims.

What is claimed is:

1. A micro reformer comprising:
a cylindrical tube having an inlet for receiving a liquid fuel and an outlet for emitting hydrogen gas;
a heater disposed in the tube for providing a heat source; and
a catalyst disposed in the tube for producing hydrogen gas from hydrocarbon-based fuel.

2. The micro reformer according to claim 1, wherein the catalyst comprises pellets charged in the tube.

3. The micro reformer according to claim 1, wherein the catalyst is coated on an inner wall of the tube.

4. The micro reformer according to claim 1, wherein the catalyst comprises a cylinder which is maintained coaxial with the tube by a support made of porous material.

5. The micro reformer according to claims 1, the outlet of the tube comprises a hydrogen permeable membrane at an end thereof for allowing passage of hydrogen.

6. The micro reformer according to claims 2, the outlet of the tube comprises a hydrogen permeable membrane at an end thereof for allowing passage of hydrogen.

7. The micro reformer according to claims 3, the outlet of the tube comprises a hydrogen permeable membrane at an end thereof for allowing passage of hydrogen.

8. The micro reformer according to claims 4, the outlet of the tube comprises a hydrogen permeable membrane at an end thereof for allowing passage of hydrogen.

9. A micro fuel cell for generating electricity from a liquid fuel comprising:
a reformer for producing hydrogen gas from a liquid fuel, the reformer including a cylindrical tube having an inlet for receiving the liquid fuel and an outlet for emitting hydrogen gas, a heater disposed in the tube for providing a heat source, and a catalyst disposed in the tube for producing hydrogen gas from hydrocarbon-based fuel;
a connector having an end connected to the outlet; and
a stack connected to the other end of the connector to receive the hydrogen gas, having a catalyst layer, an electrolyte membrane, and a coil electrode therein, thereby generating current using the hydrogen gas.

10. The micro fuel cell according to claim 9, wherein the connector is made of the same material as the tube of the reformer or a body of the stack, and is bonded with the reformer and the stack.

11. The micro fuel cell according to claim 9, wherein the reformer and the stack are linearly coaxial.

12. The micro fuel cell according to claim 9, wherein the electrode of the stack comprises wires wound in a spiral or wires woven in a net supporting and maintaining a shape of the electrolyte membrane.

13. The micro fuel cell according to claim 9, wherein the stack comprises a barrier to control the movement of hydrogen and oxygen in an inner space and an outer space of the polymer electrolyte membrane.

14. A micro fuel cell for generating electricity from a liquid fuel comprising:
a reformer for producing hydrogen gas from a liquid fuel, the reformer including a cylindrical tube having an inlet for receiving the liquid fuel and an outlet for emitting hydrogen gas, a heater disposed in the tube for providing a heat source, and a catalyst disposed in the tube for producing hydrogen gas from hydrocarbon-based fuel;
a stack wrapped around the reformer to receive the hydrogen gas, having a catalyst layer, an electrolyte membrane, and a coil electrode therein to generate current using the hydrogen gas; and
a connector for connecting the reformer and the stack to overlap each other, forming a dual cylinder.

15. The micro fuel cell according to claim 14, wherein the stack uses high temperature of heat generated from the reformer as a heat source.

16. The micro fuel cell according to claim 14, wherein the connector is a plate sealing an end of the reformer and an end of the stack to integrally fix the tube of the reformer and the body of the stack.

17. The micro fuel cell according to claim 16, further comprising a barrier at an end of the stack opposite of the connector such that hydrogen ions pass through the electrolyte membrane of the stack, moving inside or outside of the electrolyte membrane.

18. The micro fuel cell according to claim 14, wherein the reformer and the stack are connected coaxially to overlap each other, forming a dual cylinder.
